(19) United States
(12) Patent Application Publication
(10) Pub. No.: US 2014/0363649 A1
(43) Pub. Date: Dec. 11, 2014

(54) DOUBLE-SIDED TRANSPARENT CONDUCTIVE FILM HAVING EXCELLENT VISIBILITY AND A METHOD FOR MANUFACTURING THE SAME

(71) Applicant: LG Hausys, Ltd., Yeongdeungpo-gu, Seoul (KR)

(72) Inventors: Kyung Taek Kim, Bucheon-si (KR); In Sook Kim, Daejeon (KR); Jung Cho, Seoul (KR); Keun Jung, Gwacheon-si (KR); Min Hee Lee, Gunpo-si, Gyeonggi-do (KR)

(73) Assignee: LG Hausys, Ltd., Yeongdeungpo-gu, Seoul (KR)

(21) Appl. No.: 14/369,517

(22) PCT Filed: Jan. 4, 2013
(86) PCT No.: PCT/KR2013/000052

§ 371 Date: Jun. 27, 2014

(30) Foreign Application Priority Data
Jan. 6, 2012 (KR) 10-2012-0001941

(51) Int. Cl. H01B 1/08; H01B 13/00

(52) U.S. Cl. CPC H01B 1/08; H01B 13/0026
USPC 428/216; 428/217; 204/192.29

(57) ABSTRACT

A double-sided transparent conductive film and a method for manufacturing the same that may not only promote simplification of a touch panel structure and simplification of processes but also having an excellent visibility characteristic is presented.

A double-sided transparent conductive film having excellent visibility in accordance with the present invention comprises a transparent base film; a first and a second hard coating layers respectively formed on both sides of the transparent base film; a first and a second undercoating layers sequentially laminated on the first hard coating layer; a third and a fourth undercoating layers sequentially laminated on the second hard coating layer; and a first and a second transparent conductive layers respectively formed on the second and fourth undercoating layer.

On this base film, an undercoating layer is formed by wet coating or sputtering methods, and then a transparent conductive layer such as ITO is formed with the sputtering methods. Lately, as uses of large area touch panels increase, realizing low resistance of surface resistance of less than 200Ω/square and improving the visibility of the transparent conductive layer are being demanded.

Meanwhile, projected capacitive touch panels, since transparent conductive layers, which function as an upper electrode and a lower electrode of display panels, and transparent conductive layers of transparent conductive films, which is attached to an upper or a lower part of the display panels respectively, are placed at a very close location, may bring about problems of causing cross talk by generating signal interferences with each other.

Therefore, to manufacture a transparent conductive film and a transparent conductive glass in a laminated structure like this, multiple layers of OCA (optical clear adhesive) are used and attached, and this eventually brings about decrease in work efficiency and increase in manufacturing costs in accordance with the complex structures.

Also, using multiple OCAs eventually increases occurrence rates of second process defects, and it not only brings about reduction in optical properties, but also brings about problems of retrogressing trends of slimming by increasing the overall thickness of the touch panels.

For a related prior publication, there is Korea laid-open patent No. 10-2011-0072854 (disclosed 2011 Jun. 29), and in the publication, only a transparent electrode film and a manufacturing method of the same is disclosed, and there is no disclosure of a double-sided conduction film.

### DISCLOSURE

### Technical Problem

An objective of the present invention is to provide a double-sided transparent conductive film only with one transparent base layer, which may have effects of structural simplification and improvements in optical properties when it is applied to a touch panel, which is accomplished by having centrally the transparent base layer and forming two transparent conductive films thereon to result in a mutually symmetric bonding structure.

Another objective of the present invention is to provide a method for manufacturing a double-sided transparent conductive film that may reduce manufacturing costs through process simplification, which is accomplished by continuous film forming undercoating layers and transparent conductive layers in a sputtering deposition method,

### Technical Solution

A double-sided transparent conductive film having excellent visibility in accordance with an embodiment of the present invention to achieve the objective, comprises a transparent base layer; a first and a second hard coating layers respectively formed on both sides of the transparent base film; a first and a second undercoating layers sequentially laminated on the first hard coating layer; a third and a fourth undercoating layers sequentially laminated on the second hard coating layer; and a first and a second transparent conductive layers respectively formed on the second and the fourth undercoating layers.

A method for manufacturing a double-sided transparent conductive film having excellent visibility in accordance with an embodiment of the present invention to achieve another objective comprises (a) forming a first and a second hard coating layers on both sides of a transparent base film respectively; (b) forming a first and a second undercoating layers on the first hard coating layer in sequence; (c) forming a first transparent conductive layer to be deposited by sputtering a first transparent conductive material on the second undercoating layer; (d) forming a third and a fourth undercoating layers on the second hard coating layer in sequence; and (e) forming a second transparent conductive layer to be deposited by sputtering a second transparent conductive material on the fourth undercoating layer.

### Advantageous Effects

The double-sided transparent conductive film in accordance with the present invention, may have effects of structural simplification and improvements in optical properties when it is applied to a touch panel only having one transparent base layer, which is accomplished by having centrally the transparent base layer and forming two transparent conductive films thereon without using an OCA (optical clear adhesive) to result in a mutually symmetric bonding structure.

Also, the present invention may reduce manufacturing costs through process simplification by continuous film forming undercoating layers and transparent conductive layers in a sputtering deposition method using silicon (Si), niobium (Nb), ITO (Indium Tin Oxide), etc., which are easily securable raw materials.

### DESCRIPTION OF DRAWINGS

FIG. 1 is a cross sectional drawing illustrating a double-sided transparent conductive film having excellent visibility in accordance with an embodiment of the present invention.

FIG. 2 is a cross sectional drawing illustrating an enlargement of portion A of FIG. 1.

FIG. 3 is a process flow chart illustrating a method for manufacturing a double-sided transparent conductive film having excellent visibility in accordance with an embodiment of the present invention

### BEST MODE

Advantages and features of the present invention, and method for achieving thereof will be apparent with reference to the examples that follow. But, it should be understood that the present invention is not limited to the following examples and may be embodied in different ways, and that the examples are given to provide complete disclosure of the invention and to provide thorough understanding of the invention to those skilled in the art, and the scope of the invention is limited only by the accompanying claims and equivalents thereof. Like components will be denoted by like reference numerals throughout the specification.

Hereinafter, a double-sided transparent conductive film having excellent visibility and a method for manufacturing the same in accordance with an embodiment of the present invention will be described in detail in reference to accompanying drawings.

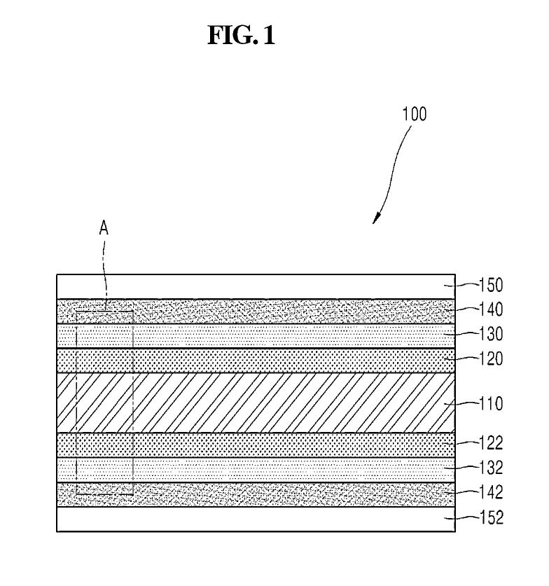

Referring to FIG. 1, a double-sided transparent conductive film (100) having excellent visibility in accordance with an embodiment of the present invention comprises a transparent base layer (110), a first and a second hard coating layers (120, 122), a first and a second undercoating layers (130, 140), a third and a fourth undercoating layers (132, 142), and a first and second transparent conductive layers (150, 152).

A film having excellent transparency and strength may be used for the transparent base layer (110). For materials for this transparent base layer, PET (polyethylene terephthalate), PEN (polyethylenenaphthalate), PES (polyethersulfone), PC (Poly carbonate), PP (poly propylene), norbornane resin, etc. may be used, and these may be used independently or by mixing 2 or more selected among them. Also, a single film form or a laminated film form may be applied for the transparent base layer (110).

For the first and the second hard coating layers (120, 122), one or more selected from an acrylic based, a urethane based, an epoxy based, siloxane polymer materials, etc. may be used. Also, the first and the second hard coating layers (120, 122) may further comprise a silica filler as an additive for improving strength.

It is preferable to form each of the first and the second hard coating layer (120, 122) with the thickness of 1.5˜7 μm. When the thickness of each of the first and the second hard coating layers (120, 122) is less than 1.5 μm, there may be difficulties in properly displaying the described effects. On the contrary, when the thickness of each of first and second hard coating layers (120, 122) is greater than 7 μm, there are problems of having greater manufacturing costs compared to increase in effects.

The first and the second undercoating layers (130, 140) are sequentially laminated on the first hard coating layer (120). These first and the second undercoating layers (130, 140) are placed between the transparent base layer (110) and the first transparent conductive layer (150), which will be describe below, and plays the role of electrically insulating between the transparent base layer (110) and a first transparent conductive layer (150) and also improving transmittance.

The third and the fourth undercoating layers (132, 142) are sequentially laminated on the first hard coating layer (122). These third and fourth undercoating layers (132, 142) are placed between the transparent base layer (110) and the second transparent conductive layer (152), which will be described below, and plays the role of electrically insulating between the transparent base layer (110) and the second transparent conductive layer (152) and also improving transmittance.

The first and the second transparent conductive layers (150, 152) are respectively formed on the second and the fourth undercoating layers (140, 142). Here, the first and the second transparent conductive layers (150, 152) may be formed with one selected from indium tin oxide (ITO), indium zinc oxide (IZO), FTO (fluorine doped tin oxide, SnO₂:F), etc.

Here, the first transparent conductive layer (150) may be a first electrode formed along the X axis, and the second transparent conductive layer (152) may be a second electrode formed along the Y axis. On the contrary, the first transparent conductive layer (150) may be the first electrode, and the second transparent conductive layer (152) may be a second electrode. Whereas, a first transparent conductive layer (150) may be a first electrode formed along the X axis and Y axis, and the second transparent conductive layer (152) may be a ground wiring for shielding noise.

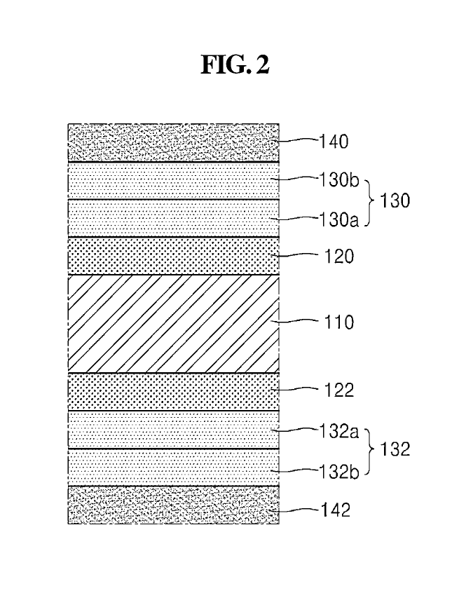

Meanwhile, FIG. 2 is a cross sectional drawing illustrating an enlargement of portion A of FIG. 1.

Referring to FIG. 2, each of the first and the third undercoating layer (130, 140) may be formed as 2 or more layers with different refractive indexes. As an example, each of the first and third undercoating layer (130, 140) may comprise a first layer (103a, 132a) having a refractive index of 1.40˜1.45, and a second layer (103b, 132b) having a second refractive index of 1.8˜2.0 on the first layer (103a, 132a).

Here, if the refractive index of each first and second transparent conductive layer (150, 152) is about 1.9˜2.0, if the refractive index difference between the first layer (130a, 132a) and the second layer (130b, 132b) of the first and the third undercoating layers (130, 132) is too large or too small, it may bring about problems of total luminous transmittance decreasing sharply due to increase in reflectivity, so it is preferable to limit the maximum refractive index difference between the first layer (103a, 132a) and the second layer (103b, 132b) of the first and the third undercoating layers (130, 132) to be 0.5˜0.6.

In this instance, it is preferable for the first layer (103a, 132a) of the first and the third undercoating layers (130, 132) to be closer to the first base layer (110) compared to the second layer (103b, 132b).

In the present invention, as a result from forming the first layer (130a, 132a) of the first and the third undercoating layers (130, 132) from one selected from SiOx, SiON, etc., adjusting the refractive index between 1.40˜1.45 was possible. And, as a result from forming the second layer (130b, 132b) of the first and the third undercoating layers (130, 132) from one selected from NbOx, SiOx, SiON, etc., adjusting the refractive index between 1.8˜2.0 was possible. From this, improvements in overall visibility and total luminous transmittance of the double-sided transparent conductive film (100) of the present invention were identified.

Here, it is preferable to form the total thickness of the first layer (103a, 132a) and the second layer (103b, 132b) of the first and the third undercoating layers (130, 132) to be 20˜100 nm. When the total thickness is formed too thin, such as being less than 20 nm, it may have difficulties of properly displaying effects of improvements in transmittance and visibility. On the contrary, when the total thickness exceeds 100 nm, it may bring about defects of cracks, etc. as membrane stress is intensified.

Meanwhile, each of the second and the fourth undercoating layers (140, 142) plays the role of further increasing visibility by decreasing the difference of reflectivity and increasing the total luminous transmittance of the second layer (103b, 132b) and the transparent base layer (110) of the first and the third undercoating layers (130, 132).

Also, the second and the fourth undercoating layers (140, 142) respectively are placed between the second layer (103b, 132b) of the first and the third undercoating layers (130, 132) and the first and the second transparent base layers (150, 152), and plays the role of blocking penetration of moisture and oligomer, etc.

These second and fourth undercoating layers (140, 142) respectively may have refractive indexes of 1.40˜1.45, same as the first layer (103a, 132a) of the first and the third undercoating layers (130, 132). For this, it is preferable to form each of the second and the fourth undercoating layer (140, 142) with SiOx, SiON, etc.

Here, it is preferable to form the thickness of each of the second and the fourth undercoating layers (140, 142) in 10˜60 nm. When the thickness of the second and the fourth undercoating layers (140, 142) is less than 10 nm, it may have difficulties of properly displaying effects of visibility improvements. On the contrary, when the thickness of the second and the fourth undercoating layer (140, 142) exceeds 60 nm, it may only increase process costs without any more effect of increase in visibility, etc.

The double-sided transparent conductive film (100) having excellent visibility in accordance with an embodiment of the present invention described above, along with being able to secure excellent optical properties through the first and the second undercoating layers (130, 140) and the third and the fourth undercoating layers (132, 142) respectively formed on both sides of a transparent base layer (110), has a structure of forming the first and the second conductive layers (150, 152) respectively to be utilized as a first electrode and second electrode of a projected capacitive touch panel on the second and the fourth undercoating layers (140, 142).

In this case, the double-sided transparent conductive film having excellent visibility in accordance with an embodiment of the present invention may, even having one transparent base layer (110), have a mutually symmetric bonding structure based on the transparent base layer by forming two transparent conductive films without using OCA (optical clear adhesive).

Therefore, when applying the double-sided transparent conductive film (100) in accordance with the present invention to the projected capacitive touch panel, the first transparent conductive layer (150) is used as the first electrode formed along an X-axis, and the second transparent conductive layer (152) is used as the second electrode formed along a Y-axis, or they may be utilized in reverse. In this case, since only attaching the double-sided transparent conductive film (100) in accordance with the top surface and the bottom surface of the touch panel is needed, compared to structures attaching the transparent conductive film on each of the upper surface and the bottom surface of the conventional touch panel, the amount of OCA used may be reduced to half. Also, since only one transparent base layer (110) is used, it has advantageous effects in realizing slim touch panels since the total thickness of the touch panel may be substantially reduced.

In addition, being laminated to a structure having a separate transparent conductive layer using OCA, the first transparent conductive layer (150) is used as an electrode formed along an X-axis or a Y-axis, and the second transparent conductive layer (152) may be used as a ground wiring for shielding noise. In this instance, along with having a noise shielding structure, it may reduce the total thickness and manufacturing process of the touch panel from the reason described above.

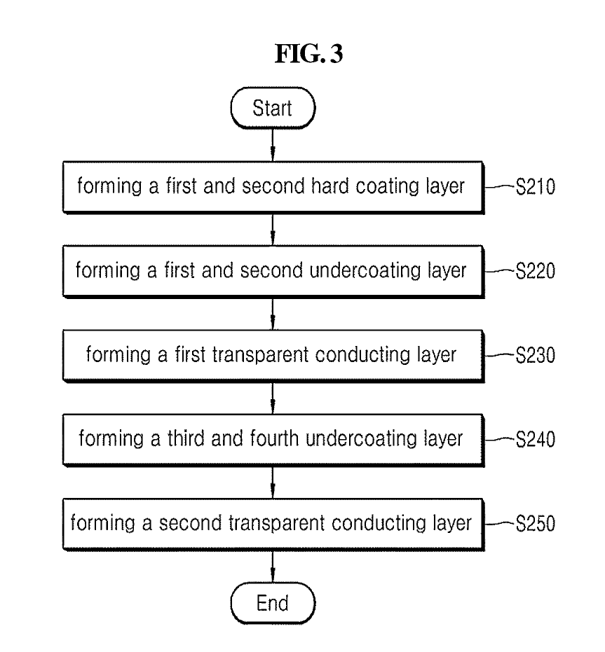

FIG. 3 is a process flow chart illustrating a method for manufacturing a double-sided transparent conductive film having excellent visibility in accordance with an embodiment of the present invention

Referring to FIG. 3, the method for manufacturing a double-sided transparent conductive film in accordance with an embodiment of the present invention comprises (S210) forming first and a second hard coating layers, (S220) forming a first and a second undercoating layers, (S230) forming a first transparent conductive layer, (S240) forming a third and a fourth undercoating layers, and (S240) forming a second transparent conductive layer.

In the forming the first and the second hard coating layers step (S210), the first and the second hard coating layers respectively are formed on one side and the other side of a transparent base layer.

Here, for materials for the transparent base layer, PET (polyethylene terephthalate), PEN (polyethylenenaphthalate), PES (polyethersulfone), PC (Poly carbonate), PP (poly propylene), norbornane resin, etc. may be used, and these may be used independently or by mixing 2 or more.

Also, for first and the second hard coating layers, one or more selected from an acrylic based, a urethane based, an epoxy based, siloxane polymer materials, etc. may be used. Here, it is preferable to form each of the first and the second hard coating layer (120, 122) to a thickness of 1.5˜7 μm.

In the forming the first and the second undercoating layer step (S220), the first and the second undercoating layers are sequentially laminated on the first hard coating layer. Here, it is preferable to form the first and the second undercoating layers with a wet coating method or a sputtering deposition method.

Describing in detail, the first undercoating layer may be formed with two or more layers with different refractive indexes. For example, the first undercoating layer may comprise a first layer having a refractive index of 1.40˜1.45 and a second layer having a refractive index of 1.8˜2.0. Here, the first undercoating layer may be formed by using a sputtering method using a Si target on the transparent film and using oxygen or nitrogen as a reactive gas, and depositing silicon oxide (SiOx) or silicon nitride having a first refractive index of 1.40˜1.45. And the second undercoating layer may be formed by using the sputtering method using a Si target or a Nb target on the first layer and using oxygen or nitrogen as reactive gas, and depositing any one of niobium oxide, silicon oxide (SiOx), and silicon nitride having a first refractive index of 1.8˜2.0. It is preferable to form the total thickness of the first and the second layers of the first undercoating layer to 20˜100 nm.

Meanwhile, the second undercoating layer may be formed, with an identical method as the first layer of the first undercoating layer, with silicon oxide (SiOx) or silicon nitride having a refractive index of 1.40˜1.45. In this instance, it is preferable to form thickness of the second undercoating layer to 10˜60 nm.

In forming the first conductive layer step (230), the first transparent conductive layer is formed [symbol] be deposited by sputtering a first transparent conductive material on the second hard coating layer. Here, it is preferable to form the first transparent conductive layer material from one selected from indium tin oxide (ITO), indium zinc oxide (IZO), FTO (fluorine doped tin oxide, SnO₂:F), etc

In forming the third and the fourth undercoating layers step (S240), the third and the fourth undercoating layers are sequentially laminated on the second hard coating layer. Here, it is preferable to form the third and the fourth undercoating layers with a sputtering deposition method.

Since these third and fourth undercoating layers may be formed with an identical structure by an identical method as the first and the second undercoating layers on the other side opposite of one of the sides of the transparent base layer, its detailed description is skipped.

In forming the second transparent conductive layer step (S250), the second transparent conductive layer is formed to be deposited by sputtering a second transparent conductive material on the fourth undercoating layer. Here, it is preferable to form the second transparent conductive layer material from one selected from indium tin oxide (ITO), indium zinc oxide (IZO), FTO (fluorine doped tin oxide, SnO₂:F), etc

And thus, the method for manufacturing the double-sided transparent conductive film having excellent visibility in accordance with an embodiment of the present invention may conclude.

As observed until now, the double-sided transparent conductive film manufactured with the process (S210˜S250) described above, even by using one transparent base layer (110), may have a mutually symmetric bonding structure based on to transparent base layer by forming two transparent conductive films without using OCA (optical clear adhesive), and thus may have effects of structural simplification and optical properties improvements.

Also, the present invention, by continuous film forming the undercoating layers and the transparent conductive layers with sputtering deposition methods using silicon (Si), niobium (Nb), ITO (Indium Tin Oxide), etc., which are easily securable raw materials, may reduce manufacturing costs of manufacturing the double-sided transparent conductive film through process simplification.

### EXAMPLES

Hereinafter, configurations and effects of the present invention are described in further detail from preferred examples of the present invention. But, this is presented as preferred examples and should not be in any way interpreted as to limit the present invention. Contents not presented in here may be inferred by anyone skilled in the arts and therefore its description is skipped.

1. Manufacturing Film

### Example 1

A first and a second hard coating layers were formed by coating and curing an acrylic hard coating solution with a thickness of 5 μm on both sides of a PET film with a thickness of 125 μm respectively, and then SiO₂ was film formed to 15 nm by a reactive sputtering method using silicon (Si) as a target on one surface, and then NbO₂ was film formed to 10 nm by a reactive sputtering method using niobium (Nb) as a target to form a first undercoating layer of a 2 layer structure with a refractive index of 1.43 and 1.9. Next, SiO₂ was film formed to 50 nm by a reactive sputtering method using silicon (Si) as a target to form a second undercoating layer, and then ITO was film formed to 20 nm by a reactive sputtering method to form a first transparent conductive layer with a refractive index of 1.95.

Next, SiO₂ was film formed to 15 nm by a reactive sputtering method using silicon (Si) as a target on the other surface, and then NbO₂ was film formed to 10 nm by a reactive sputtering method using niobium (Nb) as a target to form a third undercoating layer of a 2 layer structure with a refractive index of 1.43 and 1.9. Next, SiO₂ was film formed to 50 nm by a reactive sputtering method using silicon (Si) as a target to form a fourth undercoating layer, and then ITO was film formed to 20 nm by a reactive sputtering method to form a second transparent conductive layer with a refractive index of 1.95.

### Example 2

Other than film forming SiO₂ to 20 nm, and film forming NbO₂ to 12 nm to form the first undercoating layer of the 2 layer structure with a refractive index of 1.43 and 1.86, and film forming SiO₂ to 20 nm, and film forming NbO₂ to 12 nm to form the third undercoating layer of the 2 layer structure with a refractive index of 1.43 and 1.86, the double-sided transparent conductive film was manufactured by an identical method as Example 1.

### Example 3

Other than film forming SiO₂ to 15 nm, and film forming NbO₂ to 10 nm to form the first undercoating layer of the 2 layer structure with a refractive index of 1.41 and 1.86, and film forming SiO₂ to 15 nm, and film forming NbO₂ to 10 nm to form the third undercoating layer of the 2 layer structure with a refractive index of 1.41 and 1.86, the double-sided transparent conductive film was manufactured by an identical method as Example 1.

### Example 4

Other than film forming SiO₂ to 5 nm, and film forming NbO₂ to 20 nm to form the first undercoating layer of a 2 layer structure with a refractive index of 1.38 and 1.76, and film forming SiO₂ to 5 nm, and film forming NbO₂ to 20 nm to form the third undercoating layer of the 2 layer structure with a refractive index of 1.38 and 1.76, the double-sided transparent conductive film was manufactured by an identical method as Example 1.

### Comparative Example 1

Other than skipping the process for forming the second and the fourth undercoating layers, the double-sided transparent conductive film was manufactured by an identical method as Example 1.

### Comparative Example 2

Hard coating layers were formed by coating an acrylic hard coating solution with a thickness of 5 μm on one side of a PET film with a thickness of 125 μm respectively and curing, and then SiO₂ was film formed to 15 nm by a reactive sputtering method using silicon (Si) as a target on one surface, and then NbO₂ was film formed to 10 nm by a reactive sputtering method using niobium (Nb) as a target to form a first undercoating layer of a 2 layer structure with a refractive index of 1.43 and 1.9. Next, SiO₂ was film formed to 50 nm by a reactive sputtering method using silicon (Si) as a target to form a second undercoating layer on top of the first undercoating layer, and then ITO was film formed to 20 nm by a reactive sputtering method to form a first transparent conductive layer with refractive index of 1.95.

Next, two identical transparent conductive films were laminated using a transparent adhesive (OCA) with a thickness of 50 μm. The transparent conductive layers were placed opposite to each other in a laminated structure.

2. Evaluation of Physical Properties

Table 1 shows results of the optical properties evaluation and the thickness with respect to the films in accordance with Examples 1˜3 and Comparative example 1.

(1) Transmittance and color: transmittance and b* number based on D65 light source was obtained by measuring with a spectrophotometer based on ASTM D1003 method.

(2) Visibility: A portion of both sides of the transparent conductive layer was etched and a pattern was formed and observed by a naked eye, and pattern visibility was evaluated.

O: the transparent conductive layer pattern was not observed

Δ: the transparent conductive layer pattern was somewhat observed

X: the transparent conductive layer pattern was clearly observed

(3) Thickness: each transparent conductive film or laminated structure was measured using a digital thickness gauge.

TABLE 1

| | Transmittance | b* | Visibility | Thickness |
|---|---|---|---|---|
| Example 1 | 91.2 | 1.0 | ◯ | 130 |
| Example 2 | 89.9 | 0.7 | ◯ | 130 |
| Example 3 | 89.9 | 1.1 | ◯ | 130 |
| Example 4 | 88.7 | 1.7 | Δ | 130 |
| Comparative | 88.2 | 2.2 | X | 130 |
| example 1 | | | | |
| Comparative | 91.1 | 0.9 | ◯ | 310 |
| example 2 | | | | |

Referring to Table 1, excellent optical properties were obtained in all of Examples 1˜4, especially, in the case of films in accordance with Examples 1˜3, transmittance was 89% or over and color b* was below 1.5 and excellent optical properties corresponding to target values were identified, and this means that optical properties at a level of the single type transparent conductive film of Comparative example 2 is obtainable. Also, in the case of films in accordance with Examples 1˜3, as can be observed from the visibility evaluation results, patterns were not at all identified by the naked eye.

On the contrary, in the case of the film in accordance with Comparative example 1, transmittance and color values all showing dissatisfactory results may be identified. Also, in the case of the film in accordance with Comparative example 1, as can be seen from the visibility evaluation results, the pattern was identifiable and the pattern visibility was poor, and in the case of the film in accordance with Comparative example 2, even though it has optical properties at a level equivalent to the Examples, it is a result of laminating two sheets of a single type transparent conductive film and its thickness reached 310 μm. Based on the experimental results above, even though films according to Examples 1˜4 are double-sided coating type transparent conductive films, optical properties being excellent and ability to maintain thin thicknesses were identified.

Although described mainly by examples of the present invention, these embodiments are given by way of illustration only, it should be understood that various variations and equivalent other examples can be made by those skilled in the art. Therefore, the scope of the present invention should be defined by the appended claims and equivalents thereof.

### DESCRIPTION OF SYMBOLS

100: a double-sided transparent conductive film
110: a transparent base layer
120, 122: a first and a second hard coating layers
130, 140: a first and a second undercoating layers
132, 142: a third and a fourth undercoating layers
150, 152: a first and a second transparent conductive layers
S210: forming a first and a second hard coating layers
S220: forming a first and a second undercoating layers
S230: forming a first transparent conductive layer
S240: forming a third and a fourth undercoating layers
S250: forming a second transparent conductive layer

1. A double-sided transparent conductive film comprising,
a transparent base layer;
a first and a second hard coating layers respectively formed on both sides of the transparent base film;
a first and a second undercoating layers sequentially laminated on the first hard coating layer;
a third and a fourth undercoating layers sequentially laminated on the second hard coating layer; and
a first and a second transparent conductive layers respectively formed on the second and the fourth undercoating layer.

2. The double-sided transparent conductive film according to claim 1, wherein the transparent base layer comprises one or more selected from PET (polyethylene terephthalate), PEN (polyethylenenaphthalate), PES (polyethersulfone), PC (Poly carbonate), PP (poly propylene), and norbornane resin.

3. The double-sided transparent conductive film according to claim 1, wherein the first and the second hard coating layers comprise one or more selected from acrylic, urethane, epoxy, and siloxane polymer materials.

4. The double-sided transparent conductive film according to claim 1, wherein each of the first and the third undercoating layers has a first layer having refractive index of 1.40˜1.45, and a second layer having a second refractive index of 1.8˜2.0 on the first layer.

5. The double-sided transparent conductive film according to claim 4, wherein each of the second and the fourth undercoating layers has refractive index of 1.40˜1.45.

6. The double-sided transparent conductive film according to claim 4, wherein the total thickness of the first layer and the second layer of each of the first and the third undercoating layers is 20˜100 nm.

7. The double-sided transparent conductive film according to claim 4, wherein, for each of the first and third undercoating layers, the first layer is formed with SiOx or SiON, and the second layer is formed with one of NbOx, SiOx, and SiON.

8. The double-sided transparent conductive film according to claim 5, wherein each of the second and the fourth undercoating layer is formed with SiOx or SiON.

9. The double-sided transparent conductive film according to claim 5, wherein each of the first and the second transparent conductive layer is formed with one of indium tin oxide (ITO), indium zinc oxide (IZO), and FTO (fluorine doped tin oxide, SnO2:F).

10. A method for manufacturing a double-sided transparent conductive film comprising,
(a) forming a first and a second hard coating layers on both sides of a transparent base film respectively;
(b) forming a first and a second undercoating layers on the first hard coating layer in sequence;
(c) forming a first transparent conductive layer to be deposited by sputtering a first transparent conductive material on the second undercoating layer;
(d) forming a third and a fourth undercoating layers on the second hard coating layer in sequence; and
(e) forming a second transparent conductive layer to be deposited by sputtering a second transparent conductive material on the fourth undercoating layer.

11. The method for manufacturing a double-sided transparent conductive film according to claim 10, wherein in step (b), the first and second undercoating layers are formed in a wet coating method or in a sputtering deposition method.

12. The method for manufacturing a double-sided transparent conductive film according to claim 10, wherein in step (d), the third and fourth undercoating layers are formed in a sputtering deposition method.
